(19) United States
(12) Patent Application Publication
(10) Pub. No.: US 2008/0312384 A1
(43) Pub. Date: Dec. 18, 2008

(54) Highly Functional Highly- and Hyper- Branched Polymers and a Method for Production Thereof

(75) Inventors: Bernd Bruchmann, Freinsheim (DE); Darijo Mijolovic, Mannheim (DE); Arno Lange, Bad Durkheim (DE); Jean-Francois Stumbe, Strasbourg (FR); Daniel Schonfelder, Mannheim (DE); Andreas Eipper, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTINGESELLSCHAFT, LUDWIGSHAFEN (DE)

(21) Appl. No.: 12/097,273

(22) PCT Filed: Dec. 5, 2006
(86) PCT No.: PCT/EP06/69334

§ 371 Date: Jun. 13, 2008

(30) Foreign Application Priority Data
Dec. 16, 2005 (DE) 10-2005-060-783.7

(51) Int. Cl. C08F 283/00; C08F 22/02

(52) U.S. Cl. 525/449; 525/419

(57) ABSTRACT

High-functionality, highly branched and high-functionality, hyperbranched polymers based on polyisobutene derivatives and a process for their preparation

The present invention relates to high-functionality, highly branched and high-functionality, hyperbranched polymers based on polyisobutene derivatives, and to a process for their preparation.

Those skilled in the art know that isobutene can be oligomerized or polymerized cationically with different catalyst systems. In practice, catalyst systems which have gained significance are in particular BF₃ and AlCl₃, and also TiCl₄ and BCl₃, and TiCl₄ and BCl₃ are used in so-called “living cationic polymerization”.

Information on the polymerization of isobutene with BF₃ and AlCl₃ can be found, for example, in “Ullmann's Encyclopedia of Industrial Chemistry”, Vol. A21, 555-561 (1992) and in “Cationic Polymerizations”, Marcel Dekker Inc. 1996, 685 ff., and in the literature cited there.

TiCl₄ and BCl₃ can be used to oligomerize or polymerize isobutene cationically in a controlled manner under certain conditions. This procedure is referred to in the literature as “living cationic polymerization” (on this subject, see, for example, Kennedy and Ivan, Designed Polymers by Carbocationic Macromolecular Engineering, Hanser Publishers (1992) and the literature cited there). Detailed information can also be found in WO-A1 01/10969, and there particularly p. 8, I. 23 to p. 11, I. 23.

Both in the cationic polymerization with BF₃ and in the living cationic polymerization, highly reactive polyisobutenes are obtained. In this document, highly reactive polyisobutene is understood to mean a polyisobutene (PIB) which comprises, to an extent of at least 60 mol %, end groups formed from vinyl isomer (β-olefin, —[—CH═C(CH₃)₂]) and/or vinylidene isomer (α-olefin, —[—C(CH₃)═CH₂]) or corresponding precursors, for example —[—CH₂—C(CH₃)₂Cl]. Determination is possible by means of NMR spectroscopy.

Depending on the preparation of the polyisobutenes, the polydispersity M_{w}/Mₙ is in a range of 1.05-10, polymers from “living” polymerization usually having values between 1.05 and 2.0. Depending on the end use, low (for example 1.1-1.5, preferably around 1.3), medium (for example 1.6-2.0, preferably around 1.8) or high (for example 2.5-10, preferably 3-5) values may be advantageous.

For the process according to the invention, it is possible to use polyisobutenes within a molecular weight range Mₙ of from approx. 100 to approx. 100000 daltons, preference being given to molecular weights of from approx. 200 to 60000 daltons. Particular preference is given to polyisobutenes having an approximate number-average molecular weight Mₙ of 550-32000 daltons.

In the context of this document, the molecular weights reported are determined by gel permeation chromatography with polystyrene as the standard and tetrahydrofuran as the eluent.

The method for determining the polydispersity and for the number-average and weight-average molecular weight Mₙ and M_{w} is described in Analytiker Taschenbuch [Analysts' Handbook] Vol. 4, pages 433 to 442, Berlin 1984.

In the case of BF₃ catalysis and of living cationic polymerization of pure isobutene, homopolymeric polyisobutene is obtained which comprises, for example, more than 80 mol %, preferably more than 90 mol % and more preferably more than 95 mol % of isobutene units, i.e. 1,2-bonded monomers in the form of 1,1-dimethyl-1,2-ethylene units.

For the synthesis of suitable starting materials in a step a), preference is given to using pure isobutene. However, it is additionally also possible to use cationically polymerizable comonomers. However, the amount of comonomers should generally be less than 20% by weight, preferably less than 10% by weight and in particular less than 5% by weight.

Useful cationically polymerizable comonomers are in particular vinylaromatics such as styrene and α-methylstyrene, C₁-C₄-alkylstyrenes such as 2-, 3- and 4-methylstyrene and 4-tert-butylstyrene, C₃- to C₆-alkenes such as n-butene, isoolefins having from 5 to 10 carbon atoms such as 2-methylbutene-1,2-methylpentene-1,2-methylhexene-1,2-ethylpentene-1,2-ethylhexene-1 and 2-propylheptene-1.

Suitable isobutenic feedstocks for the process according to the invention are both isobutene itself and isobutenic C₄ hydrocarbon streams, for example C₄ raffinates, C₄ cuts from isobutane dehydrogenation, C₄ cuts from steam crackers or so-called FCC crackers (FCC: Fluid Catalyzed Cracking), provided that they have been freed substantially of 1,3-butadiene present therein. Typically, the concentration of isobutene in C₄ hydrocarbon streams is in the range from 40 to 60% by weight.

Suitable isobutenic feedstocks for the polymerization should generally comprise less than 500 ppm, preferably less than 200 ppm of 1,3-butadiene. The presence of butene-1, cis- and trans-butene-2 is substantially uncritical for the polymerization and does not lead to selectivity losses.

In the case of use of C₄ hydrocarbon streams as a starting material, the hydrocarbons other than isobutene generally assume the role of an inert solvent or are copolymerized as a comonomer.

Useful solvents include all organic compounds which are liquid within the pressure and temperature range selected for the preparation of the polyisobutenes, and neither release protons nor have free electron pairs.

Examples include cyclic and acyclic alkanes such as ethane, iso- and n-propane, n-butane and its isomers, cyclopentane and n-pentane and its isomers, cyclohexane and n-hexane and isomers thereof, cycloheptane and n-heptane and isomers thereof, and higher homologs; cyclic and acyclic alkenes such as ethene, propene, n-butene, cyclopentene and n-pentene, cyclohexene and n-hexene, n-heptene; aromatic hydrocarbons such as benzene, toluene or the isomeric xylenes. The hydrocarbons may also be halogenated. Examples are methyl chloride, methyl bromide, methylene chloride, methylene bromide, ethyl chloride, ethyl bromide, 1,2-dichloroethane, 1,1,1-trichloroethane, chloroform or chlorobenzene.

It is also possible to use mixtures of the solvents. Particularly simple solvents from a process technology point of view are those which boil within the desired temperature range.

In AlCl₃-catalyzed polymerization, AlCl₃ can also be used as a complex with electron donors and in mixtures. Electron donors (Lewis bases) are compounds which have a free electron pair (for example on an oxygen, nitrogen, phosphorus or sulfur atom) and can form complexes with Lewis acids. This complex formation is desired in many cases, since the activity of the Lewis acid is thus lowered and side reactions are suppressed. Examples of electron donors are ethers such as diisopropyl ether or tetrahydrofuran, amines such as triethylamine, amides such as dimethylacetamide, alcohols such as methanol, ethanol, i-propanol or tert-butanol. Alcohols such as methanol, ethanol or i-propanol or ubiquitous traces of water also act as a proton source and thus initiate the polymerization.

The products of an AlCl₃-catalyzed polymerization (“AlCl₃ products”) comprise either copolymerized n-butenes and/or rearranged i-butenes, so that their ¹H NMR spectrum (measured at 25° C. in CDCl₃) is complex. The polymer chain, like the product obtained by polymerization with BF₃ (“BF₃ product”), does exhibit the following ¹H NMR signals with strong intensity:

1) terminal tert-butyl group: 0.98-1.00 ppm
2) methyl groups: 1.08-1.13 ppm
3) methylene groups: 1.40-1.45 ppm

In addition, however, there is a significantly higher number of signals with low intensity in the 0.9-1.5 ppm range, which usually make up 10-40% of the total integral of the aliphatic protons. Moreover, the integration shows that less than 50 mol % of the polyisobutene chains are terminated by a tert-butyl group.

Such polyisobutenes are sold, for example, under the name Hyvis® (by BP-Amoco) or Parapol® (by Exxon Chemicals).

In the BF₃-catalyzed polymerization, BF₃ can also be used as a complex with electron donors and in mixtures. As in the AlCl₃ catalysis, alcohols such as methanol, ethanol or i-propanol or ubiquitous traces of water act as electron donors and also as a proton source, which thus initiate the polymerization. However, unlike the “AlCl₃ polyisobutenes”, the commercially available “BF₃ polyisobutenes” are homopolymeric, so that their ¹H NMR spectrum is substantially simpler. The polymer chain exhibits the following signals:

1) terminal tert-butyl group: 0.98-1.00 ppm
2) methyl groups: 1.08-1.13 ppm
3) methylene groups: 1.40-1.45 ppm

The integrals of 1:2:3 vary as 9:6n:2n where n is the degree of polymerization.

A further special feature with respect to “AlCl₃ products” is the influence on the second chain end (the first being the tert-butyl group). In the BF₃-catalyzed polymerization, substantially linear polyisobutenes are obtained which, at one chain end, comprise a particularly high content of α-olefinic (—[—C(CH₃)═CH₂], vinylidene group) and β-olefinic (—[—CH═C(CH₃)₂], vinyl group). According to the invention, at least 60 mol %, preferably at least 80 mol %, of the polyisobutene used have α- or β-olefinic end groups.

Such polymers are sold, for example, under the name Glissopal® (by

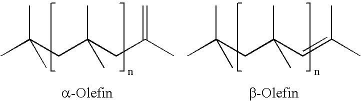

BASF AG), such as Glissopal® 1000 with an Mₙ of 1000, Glissopal® V 33 with an Mₙ of 550 and Glissopal® 2300 with an Mₙ of 2300.

Regarding the uniformity of the compounds (“AlCl₃ products” and “BF₃ products”), it is also possible to refer to Günther, Maenz, Stadermann in Angew. Makromol. Chem. 234, 71 (1996).

Polyisobutenes which have reactive α-olefin groups on two or more chain ends can be obtained by means of living cationic polymerization. It will be appreciated that it is also possible to synthesize linear polyisobutenes which have an α-olefin group only on one chain end with this method.

In the “living cationic polymerization” with TiCl₄ and BF₃, isobutene is reacted in the presence of an initiator and of a Lewis acid. Details of this method of polymerization are described, for example, in Kennedy and Ivan, “Carbocationic Macromolecular Engineering”, Hanser Publishers 1992. An initiator molecule (“inifer”) has one or more leaving group(s) X, Y or Z which can be eliminated, so that a carbocation forms, at least briefly and/or in a small concentration. Suitable leaving groups X, Y or Z may be:

the halogens fluorine, chlorine, bromine and iodine or
straight-chain and branched alkoxy groups CₙH₂ₙ₊₁O— (where n ranges from 1 to 6) such as CH₃O—, C₂H₅O—, n-C₃H₇O—, i-C₃H₇O—, n-C₄H₉O—, i-C₄H₉O—, sec-C₄H₉O—, tert-C₄H₉O—, straight-chain and branched carboxyl groups CₙH₂ₙ₊₁C(O)—O— (where n ranges from 1 to 6) such as CH₃C(O)—O—, C₂H₅C(O)—O—, n-C₃H₇C(O)—O—, i-C₃H₇C(O)—O—, n-C₄H₉C(O)—O—, i-C₄H₉C(O)—O—, sec-C₄H₉C(O)—O—, tert-C₄H₉C(O)—O—.

Connected to the leaving group X, Y or Z is a molecular moiety which can form sufficiently stable carbocations.

This may be a straight-chain or branched alkyl radical CₙH₂ₙ₊₁ (where n ranges from 4 to 30), such as in n-C₄H₉—X, i-C₄H₉—X, sec-C₄H₉—X, tert-C₄H₉—X, (CH₃)₃C—CH₂—C(CH₃)₂—X, (CH₃)₃C—CH₂—C(CH₃)₂CH₂—C(CH₃)₂—X, (CH₃)₃C—CH₂—C(CH₃)₂CH₂—C(CH₃)₂CH₂—C(CH₃)₂—X, (CH₃)₃C—CH₂—C(CH₃)₂CH₂—C(CH₃)₂CH₂—C(CH₃)₂CH₂—C(CH₃)₂—X. Preference is given to structures which can form tertiary carbocations. Particular preference is given to radicals which derive from lower oligomers of isobutene: C₄ₙH₈ₙ₊₁—X (where n ranges from 2 to 5).

Initiator molecules which can initiate a plurality of polymerization chains have, as the basic structure, for example, a straight-chain or branched alkylene radical CₙH₂ₙ (where n ranges from 4 to 30), such as X—(CH₃)₂C—CH₂—C(CH₃)₂—Y, X—(CH₃)₂C—CH₂—C(CH₃)₂CH₂—C(CH₃)₂—Y, X—(CH₃)₂C—CH₂—C(CH₃)₂CH₂—C(CH₃)₂CH₂—C(CH₃)₂—Y, X—(CH₃)₂C—CH₂—C(CH₃)₂CH₂—C(CH₃)₂—CH₂—C(CH₃)₂—CH₂—C(CH₃)₂—Y. Preference is given to structures which can form tertiary carbocations. Particular preference is given to radicals which derive formally from lower oligomers of isobutene: X—C₄ₙH₈ₙ—Y (where n ranges from 2 to 5).

The radicals described may additionally be unsaturated. Preference is given to combinations in which allyl cations can form. One example is: X—(CH₃)₂C—CH═CH—C(CH₃)₂—Y.

It may also be a cyclic, optionally unsaturated and/or aromatic hydrocarbon radical CₙH₂ₙ₋ₘ where n ranges from 3 to 20 and m from 0 to 18. Examples are C₆H₅—C(CH₃)₂—X, Y—C(CH₃)₂—C₆H₄—C(CH₃)₂—X as the para- and meta-isomer, Y—C(CH₃)₂—C₆H₃—(C(CH₃)₂—X)—C(CH₃)₂-Z as the 1,2,4- and 1,3,5-isomer; cycloalkene derivatives such as cyclopentenyl chloride or cyclohexenyl chloride. When the initiator molecules bear n leaving groups (for example Cl—C(CH₃)₂—C₆H₄—C(CH₃)₂—Cl where n=2), polyisobutenes which bear n end groups are formed.

The catalyst in a “living cationic polymerization system” is a Lewis acid such as AlHaI₃, TiHaI₄, BHaI₃, SnHaI₄ or ZnHaI₂, where Hal is fluorine, chlorine, bromine and iodine and may be the same or different within the molecule, and also mixtures thereof, preferably TiHaI₄ and more preferably TiCl₄.

If appropriate, an electron donor may be added as a cocatalyst. These are compounds which have a free electron pair (for example on an oxygen, nitrogen, phosphorus or sulfur atom) and can form complexes with Lewis acids. This complex formation is desired in many cases, since the activity of the Lewis acid is thus lowered and side reactions are suppressed.

Examples of electron donors are ethers such as diisopropyl ether or tetrahydrofuran, amines such as triethylamine, amides such as dimethylacetamide, esters such as ethyl acetate, thioethers such as methyl phenyl sulfide, sulfoxides such as dimethyl sulfoxide, nitriles such as acetonitrile, phosphines such as trimethylphosphine, pyridine or pyridine derivatives.

Certain pyridine derivatives, for example 2,6-di-tert-butylpyridine, also act as “proton traps” and thus prevent a further cationic polymerization mechanism from becoming active via protons (from ubiquitous traces of water).

The polyisobutenes obtainable here are homopolymeric like the BF₃-catalyzed polymerization, so that their ¹H NMR spectrum is simple. The polymer chain exhibits the following signals:

2) methyl groups: 1.08-1.13 ppm
3) methylene groups: 1.40-1.45 ppm

The integrals of 2:3 vary as 3n:1n, where n is the degree of polymerization.

In addition, signals of the initiator molecule may occur when the initiator used is not hydrochlorinated isobutene oligomers, for example 2-chloro-2,4,4,6,6-penta-methylheptane.

As in the BF₃-catalyzed polymerization, a high content of α-olefinic (—[—C(CH₃)═CH₂], vinylidene groups) and β-olefinic (—[—CH═C(CH₃)₂], vinyl group) end groups is achieved. According to the invention, at least 60 mol %, preferably at least 80 mol % of the polyisobutene used has α- or β-olefinic end groups.

However, in the case of living cationic polymerization, depending on the selection of the initiator molecule, the possibility exists of forming not just one end group but also a plurality of end groups in one polyisobutene chain by virtue of branches. In the polymers terminated olefinically only at one chain end, the data for the α- or β-olefin fraction relate only to this one chain end. In the case of the polymers terminated olefinically at both chain ends, and also the branched products, these data relate to the total number of all chain ends, so that chains which have α- and α-chain ends can also occur.

In the case of BF₃ catalysis and living cationic polymerization, in contrast to AlCl₃ catalysis, homopolymeric highly reactive polyisobutenes are obtained which comprise, for example, more than 80 mol %, preferably more than 90 mol % and more preferably more than 95 mol % of isobutene units. In this document, highly reactive polyisobutenes refer only to those which, in total, have at least 60 mol %, preferably at least 80 mol % of reactive, i.e. α- or β-olefinic, groups at the chain end.

The reactive groups at the chain ends may in principle be any groups, provided that they can be converted to a terminal polar group by a suitable reaction. The reactive groups are preferably α- or β-olefin groups, and also —CH₂—C(CH₃)₂-Z— groups where Z may assume the abovementioned definitions, which can be converted directly or after elimination via the olefin stage.

The polyisobutylene obtainable as described above in a step a) is, if appropriate, purified in a step b) and subsequently, in a step c), reacted with an enophile selected from the group of fumaryl chloride, fumaric acid, itaconic acid, itaconyl chloride, maleyl chloride, maleic anhydride and/or maleic acid, preferably with maleic anhydride or maleyl chloride, more preferably with maleic anhydride, to give succinic acid derivatives of the general formula (IIa), (IIb) or (IIc), where PIB may be a polyisobutylenyl group obtained by any polymerization and having a number-average molecular weight Mₙ of from 100 to 100000 daltons.

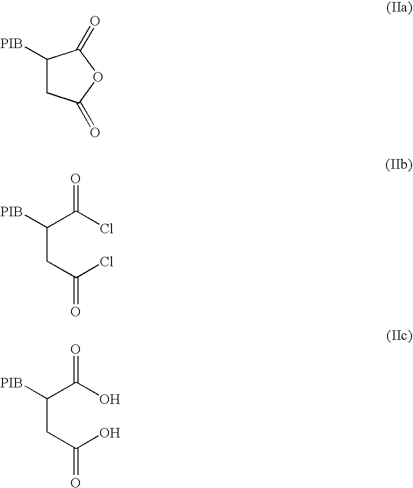

The reaction is effected by the processes known to those skilled in the art and preferably as described in the processes for reacting polyisobutylenes with enophiles described in German published specifications DE-A 195 19 042, therein preferably from p. 2, I. 39 to p. 4, I. 2 and more preferably from p. 3, I. 35-58, and DE-A 43 19 671, therein preferably from p. 2, I. 30 to I. 68, and DE-A 43 19 672, therein preferably from p. 2, I. 44 to p. 3, I. 19.

The number-average molecular weight Mₙ of the thus obtainable succinic anhydride derivative substituted by a polyisobutylenyl group, known as “PIBSA”, can be characterized by means of the hydrolysis number according to DIN 53401 in the unit mg KOH/g of substance.

Since a new double bond which can likewise react with maleic anhydride is formed in the reaction with maleic anhydride, the thus obtainable succinic anhydrides substituted by a polyisobutylene group generally have a ratio of from 0.9 to 1.5, preferably from 0.9 to 1.1 succinic anhydride groups per polyisobutylene chain. More preferably, each polyisobutylene chain bears only one succinic anhydride group.

The synthesis of PIBSA is known in the literature as the ene reaction between maleic anhydride and polyisobutenes (see, for example, DE-A 43 19 672, EP-A 156 310 or H. Mach and P. Rath in Lubrication Science II (1999), p. 175-185).

The ene reaction of the polyisobutene with the enophile can, if appropriate, be carried out in the presence of a Lewis acid as a catalyst. Suitable examples are AlCl₃ and EtAlCl₂.

During the ene reaction, a new α-olefin group is obtained at the chain end and is in turn again reactive. It is known to those skilled in the art that a reaction with further maleic anhydride affords a product which can thus bear two succinic anhydride groups per reactive chain end of the polyisobutene. This means that a polyisobutene from BF₃ catalysis, depending on the performance of the ene reaction, may bear one or even two succinic anhydride groups per chain. Consequently, polyisobutenes from living cationic polymerization in the reaction

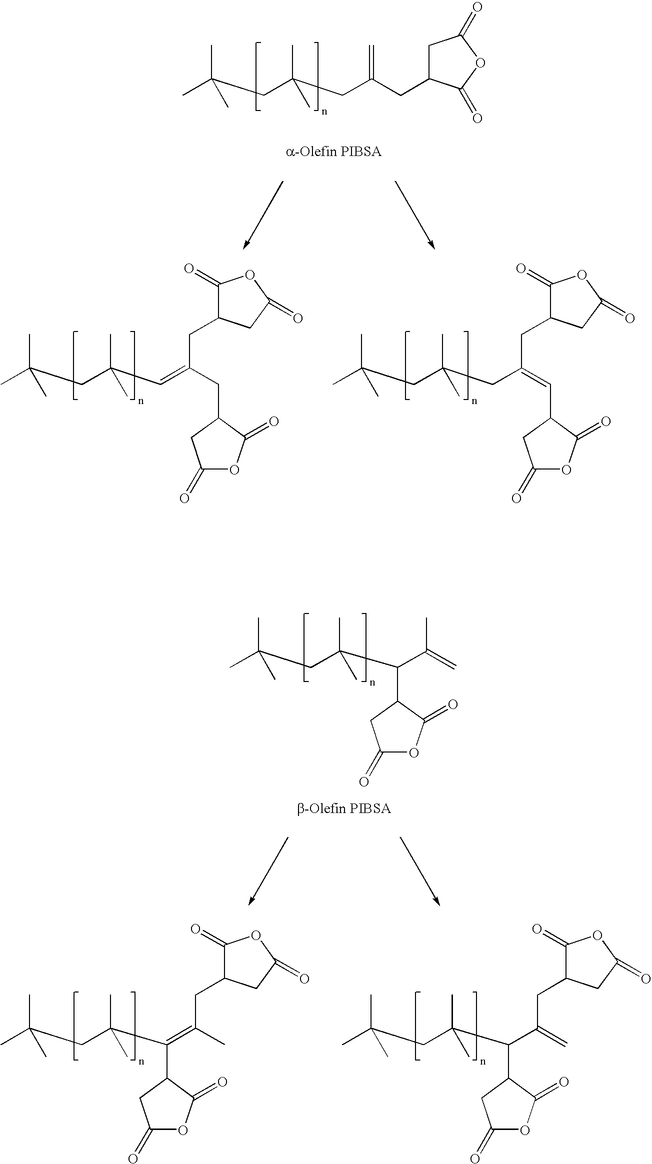

with maleic anhydride may likewise be mono- or disubstituted per reactive chain end. Thus, polyisobutenes are possible not just with one, but also with two and more succinic anhydride groups per molecule.

Shown above is an exemplary illustration of the product isomers of the ene reaction and double ene reaction of an ideal polyisobutene having a single reactive chain end. Isomers are shown with one or two succinic anhydride group(s) on one chain end. Analogously, however, PIBSAs having two and more chain ends are accordingly possible with one or two succinic anhydride radicals per chain end in the different isomeric variants of mono- and disubstitution. The number of possible isomers thus rises sharply with the number of chain ends. The person skilled in the art knows that, depending on the reaction, different substitution patterns can be realized with different isomer contents of the PIBSA.

The degree of functionalization, i.e. the fraction of the α- or β-olefinic end groups reacted with the enophile in the polyisobutene, of the polyisobutylene derivatives modified with terminal succinic anhydride groups is in total at least 65 mol %, preferably at least 75 mol % and most preferably at least 85 mol %. In the case of the polymers with only one reactive chain end, the degree of functionalization relates only to this one functional group with the two possible isomers α- and β-olefin PIBSA. In the disubstituted and polysubstituted PIBSAs, the data for the degrees of functionalization are based on the total number of all functional groups within one molecule chain. Depending on whether mono- or disubstitution is present at one chain end, isomers depicted above are present in varying fractions.

The nonfunctionalized chain ends may either be those which have no reactive group at all (i.e. no α- or β-olefin radical) or those which do have a reactive group (α- or β-olefin radical) but which have not been reacted with maleic anhydride in the course of the ene reaction. In summary, the degree of functionalization thus relates only to the number of all functional groups present in one polymer chain, but not their possible isomers.

In addition, the copolymerization of maleic anhydride and polyisobutenes is also described, for example in WO 90/03359, EP B1 644 208, EP B1 744 413. The products thus prepared are known under the name polyPIBSA. In comparison to the ene reaction, however, copolymerization plays a comparatively minor role.

This copolymerization of maleic anhydride and polyisobutenes, using free-radical initiators, forms alternating copolymers with comb structure. No homopolymers are known either of maleic anhydride or of polyisobutenes with olefinic end groups. It can thus be assumed that polyPIBSAs have a strictly alternating structure. A degree of functionalization as for the PIBSAs with terminal succinic anhydride units from the ene reaction cannot be specified. The structure of polyPIBSAs is depicted below.

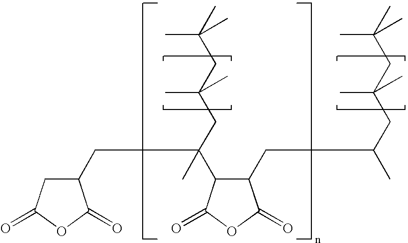

For the further reaction of a polyisobutene which has been functionalized with one or more succinic anhydride groups and, if appropriate, purified in a step d), there are the following derivatization variants known to those skilled in the art. Comprehensive descriptions can be found, for example, in DE-A1 101 251 58:
1) reacting with at least one amine to obtain a polyisobutene functionalized at least partly with succinimide groups and/or succinamide groups,
2) reacting with at least one alcohol to obtain a polyisobutene functionalized at least partly with succinic ester groups,
3) reacting with at least one thiol to obtain a polyisobutene functionalized at least partly with succinic thioester groups,
4) converting the free succinic acid groups to salts. Useful cations in salts are in particular alkali metal cations, ammonium ions and alkylammonium ions.

Highly branched and hyperbranched polyesters based on dicarboxylic acids and polyols are described, for example, in DE 102 19 508 and DE 102 40 817.

Highly branched and hyperbranched polyesteramides based on dicarboxylic acids and amino alcohols are known, for example, from the following documents:

EP 1 036 106 describes the reaction of dicarboxylic anhydrides (phthalic anhydride and hexahydrophthalic anhydride) with dialkanolamines, especially diisopropanolamine, to give branched polyesteramines. PIB-modified acid anhydrides are not mentioned. The possibility of hydrophilic or hydrophobic modification of the polyesteramides mentioned by means of polyethylene glycol groups or long-chain alkanes is described, for example, by D. Muscat and R. A. T. M. van Benthem in Topics in Current Chemistry, Vol. 212, page 41-80, Springer Verlag Berlin-Heidelberg 2001.

Mention should also be made of German patent application 10 2004 039102.5, application date Aug. 11, 2004.

Highly branched and hyperbranched polyamides are known, for example, from German patent application 10 2004 039101.7, application date Aug. 11, 2004.

Reactions of PIBSA with amines or alcohols are known.

US 2004/0102338 describes the reaction of PIBSA with polyfunctional amines and polyamines to give succinimides. Highly branched polymers according to the present application are not mentioned.

EP 291 521 describes the preparation of sulfur-containing compositions as a lubricant and fuel additive. In this case, PIBSA is reacted either with di- or trifunctional amines or else with sorbitol to give polyamides or polyesters. The molar feedstock ratio of PIBSA to amine or alcohol is generally from 1:0.5 to 1:0.75.

U.S. Pat. No. 5,587,432 describes oil-soluble dispersants, for which PIBSA is reacted with alkoxylated diethylenetriamine in a molar ratio of greater than or equal to 2:1.

US 2004/0266955 describes the preparation of esterified copolymers as a lubricant or fuel additive, an intermediate being obtained by the reaction of PIBSA with pentaerythritol in a molar ratio of about 1:0.5. This affords polymers having an Mₙ up to 000 (claim 15).

The present invention relates to high-functionality, highly branched or high-functionality, hyperbranched polymers formed in a controlled way and based on acid-containing polyisobutylenes, preferably the reaction products formed from polyisobutene and maleic anhydride (PIBSA).

The inventive polymers are obtained by reactions of PIBSAs with functional monomers reactive toward acid groups or acid group derivatives. According to the invention, the PIBSAs used for this purpose may be any which possess one or more succinic anhydride group(s). Preference is given to using PIBSA derivatives which possess one anhydride group. These PIBSAs are reacted, if appropriate in a mixture with other mono-, di-, tri- or polycarboxylic acids, with molecules comprising groups which are reactive toward a carboxylic acid, a carboxylic ester, a carbonyl halide or a carboxylic anhydride.

These are, for example, molecules which comprise hydroxyl (—OH), mercapto (—SH), primary or secondary amino groups, imino groups or epoxy groups; preference is given to molecules comprising hydroxyl groups and primary or secondary amino groups. The functionality of these molecules should on average be greater than two, preferably three or four. The application further relates to a process for preparing these highly branched molecules based on PIBSA and to their use.

The inventive high-functionality, highly branched or high-functionality, hyperbranched polymers may be used in an industrially advantageous manner, inter alia, as mineral oil additives, lubricants, detergents, adhesion promoters, thixotropic agents or units for preparing polyaddition or polycondensation polymers, for example varnishes, coatings, adhesives, sealants, cast elastomers or foams.

The inventive high-functionality, highly branched or high-functionality, hyperbranched polymers belong to the substance classes of the polyesters, polyesteramides or polyamides.

Polyesters are obtained typically from the reaction of carboxylic acids with alcohols. Industrially significant polyesters are aromatic polyesters which are prepared, for example, from phthalic acid, isophthalic acid or terephthalic acid and ethanediol, propanediol or butanediol, and aliphatic polyesters prepared from succinic acid, glutaric acid or adipic acid with ethanediol, propanediol, butanediol, pentanediol or hexanediol. On this subject, see also Becker/Braun, Kunststoff-Handbuch [Plastics Handbook] Vol. 3/1, Polycarbonate, Polyacetale, Polyester, Celluloseester [polycarbonates, polyacetals, polyesters, cellulose esters], Carl-Hanser-Verlag, Munich 1992, pages 9-116, and Becker/Braun, Kunststoff-Handbuch Vol. 7, Polyurethane [polyurethanes], Carl-Hanser-Verlag, Munich 1993, pages 67-75. The aromatic or aliphatic polyesters described here are generally linear, strictly difunctional, or else have a low degree of branching.

U.S. Pat. No. 4,749,728 describes a process for preparing a polyester from trimethylolpropane and adipic acid. The process is carried out in the absence of solvents and catalysts. The water formed in the reaction is removed by simply distilling it off. The products thus obtained can be reacted, for example, with epoxides and processed to give thermally curing coating systems.

EP-A 0 680 981 discloses a process for synthesizing polyester polyols, which consists in heating a polyol, for example glycerol, and adipic acid to 150-160° C. in the absence of catalysts and solvents. The products obtained are suitable as polyester polyol components for rigid polyurethane foams.

WO 98/17123 discloses a process for preparing polyesters from glycerol and adipic acid which are used in chewing gum mixtures. They are obtained by a solvent-free process without use of catalysts, After 4 hours, gels begin to form. However, gel-type polyester polyols are undesired for numerous applications, for example printing inks and adhesives, because they can tend to form lumps and reduce the dispersion properties.

WO 02/34814 describes the preparation of lightly branched polyesterols for powder coatings by converting aromatic dicarboxylic acids together with aliphatic dicarboxylic acids and diols, and also with small amounts of a branching agent, for example of a triol or of a tricarboxylic acid.

High-functionality polyesters with a defined structure have only become known in recent times.

For instance, WO 93/17060 (EP 630 389) and EP 799 279 describe dendrimeric and hyperbranched polyesters based on dimethylolpropionic acid which, as an AB₂ unit (A=acid group, B=OH group), condenses intermolecularly to polyesters. The synthesis is very inflexible since it relies on dimethylolpropionic acid as the sole feedstock. In addition, dendrimers are too costly for general use because even the AB₂ units as feedstocks are generally expensive and the syntheses are multistage and high demands are made on the purity of the intermediates and end products.

WO 01/46296 describes the preparation of dendritic polyesters in a multistage synthesis starting from a central molecule such as trimethylolpropane, dimethylolpropionic acid as the AB₂ unit, and also a dicarboxylic acid or a glycidyl ester as functionalizing agents. This synthesis likewise relies on the presence of the AB₂ unit.

WO 03/070843 and WO 03/070844 describe hyperbranched copolyester polyols based on AB₂ or else AB₃ units and a chain extender, which are used in coatings systems. For example, dimethylolpropionic acid and caprolactone are used as feedstocks. This method too is dependent upon an AB₂ unit.

EP 1109775 describes the preparation of hyperbranched polyesters with a tetrafunctional central group. Here, a dendrimer-like product is formed starting from pentaerythritol as the central molecule and finds use in varnishes.

EP 1070748 describes the preparation of hyperbranched polyesters and their use in powder coatings. The esters, again based on dimethylolpropionic acid as the AB₂ unit, are added to the varnish system in amounts of 0.2-5% by weight as flow improvers.

DE 101 63 163 and DE 10219508 describe the preparation of hyperbranched polyesters based on an A₂+B₃ approach. This principle is based on the use of dicarboxylic acids and triols or based on tricarboxylic acids and diols. The flexibility of these syntheses is significantly higher, since they do not rely on the use of an AB₂ unit.

Further hyperbranched polyesters are known from DE 102 19 508 and DE 102 40 817.

Polyesteramides are obtained typically from the reaction of dicarboxylic acids with alkanolamines.

EP-A 1 295 919 mentions the preparation of, inter alia, polyesteramides from monomer pairs Aₛ and Bₜ where s≧2 and t≧3. The polyesteramide used is a commercial product; no further information is given on the preparation of the polyesteramides, in particular on molar ratios.

WO 00/56804 describes the preparation of polymers with esteralkylamide-acid groups by reacting an alkanolamine with a molar excess of a cyclic anhydride, the anhydride alkanolamine equivalents ratio being from 2:1 to 3:1. The anhydride excess is thus at least twofold. Instead of the anhydride, it is also possible to use a dicarboxylic monoester, anhydride or thioester, the carboxylic acid compound:alkanolamine ratio again being from 2:1 to 3:1.

WO 99/16810 describes the preparation of hydroxyalkylamide-containing polyesteramides by polycondensing mono- or bishydroxyalkylamides with a dicarboxylic acid, or by reacting a cyclic anhydride with an alkanolamine. The anhydride:alkanolamine equivalents ratio is from 1:1 to 1:1.8, i.e. the anhydride is the deficient component.

In Topics in Current Chemistry 2001, Volume 212, pages 41-80, Muscat et al. disclose hyperbranched polyesteramides. Pages 54-57 describe their preparation by reacting diisopropanolamine (DIPA) with an excess of cyclic anhydrides or an excess of dicarboxylic acids, for example adipic acid, in which case the polyesteramide is obtained only at a molar adipic acid:DIPA ratio of 3.2:1, but not at a ratio of 2.3:1.

Moreover, mention should be made here of German patent application 10 2004 039101.7, application date Aug. 11, 2004.

Polyamides are typically prepared from the reaction of dicarboxylic acids with di- or polyamines.

U.S. Pat. No. 6,541,600 B₁ describes the preparation of water-soluble highly branched polyamides, inter alia, from amines R(NH₂)ₚ and carboxylic acids R(COOH)_{q}, where p and q are in each case at least 2, and p and q are not simultaneously 2. Some of the monomer units comprise an amine, phosphine, arsenine or sulfide group, which is why the polyamide comprises nitrogen, phosphorus, arsenic or sulfur atoms which form onium ions. The molar ratio of the functional groups is specified very widely with NH₂ to COOH or COOH to NH₂ equal to from 2:1 to 100:1.

EP-A 1 295 919 mentions the preparation of, inter alia, polyamides from monomer pairs Aₛ and Bₜ where s≧2 and t≧3, for example from tris(2-aminoethyl)amine and succinic acid or 1,4-cyclohexanedicarboxylic acid in a molar triamine:dicarboxylic acid ratio of 2:1, i.e. with an excess of the trifunctional monomer.

US 2003/0069370 A1 and US 2002/0161113 A1 disclose the preparation of, inter alia, hyperbranched polyamides from carboxylic acids and amines, or of polyamidoamines from acrylates and amines, the amine being at least difunctional and the carboxylic acid or the acrylate at least trifunctional, or vice versa. The molar ratios of difunctional to trifunctional monomer may be less than or greater than one; more precise specifications are not made. In example 9, a polyamidoamine is prepared in a Michael addition from N(C₂H₄NH₂)₃ and N(CH₂CH₂N(CH₂CH₂COOCH₃)₂)₃.

Moreover, mention should be made here of German patent application 10 2004 039101.7, application date Aug. 11, 2004.

It was an object of the invention to provide, by means of a technically simple and inexpensive process starting from commercial and inexpensive starting components, high-functionality and highly branched polymers whose hydrophilic/hydrophobic balance is adjustable within wide ranges by virtue of the selection of the monomers.

The object is achieved by high-functionality, highly branched or high-functionality, hyperbranched compounds obtainable by reacting

at least one dicarboxylic acid (A₂) having at least one polyisobutene group or derivatives thereof,

if appropriate at least one aliphatic, cycloaliphatic, araliphatic or aromatic carboxylic acid (D₂) which has exactly two carboxylic acid groups or derivative thereof,

if appropriate at least one aliphatic, cycloaliphatic, araliphatic or aromatic carboxylic acid (D_{y}) which has more than two carboxylic acid groups or derivative thereof, at least one compound having at least two groups reactive toward carboxylic acid groups or derivatives thereof, selected from the group consisting of
divalent aliphatic, cycloaliphatic, araliphatic or aromatic compounds (B₂) which have exactly two identical or different groups reactive toward carboxylic acid groups or derivatives thereof, and
aliphatic, cycloaliphatic, araliphatic or aromatic compounds (Cₓ) which have more than two identical or different groups reactive toward carboxylic acid groups or derivatives thereof,

at least one compound (D_{y}) and/or (Cₓ) being present and

the ratio of the reactive partners in the reaction being selected so as to maintain a molar ratio of molecules having groups reactive toward acid groups or derivatives thereof to molecules having acid groups or derivatives thereof of from 2:1 to 1:2.

The reaction is carried out under reaction conditions under which acid groups or derivatives thereof and groups reactive toward acid groups or derivatives thereof react with one another.

The invention further provides a process for preparing high-functionality, highly branched or high-functionality, hyperbranched polymers, at least comprising the steps of:
a) either reacting at least one dicarboxylic acid (A₂) having at least one polyisobutylene group or derivatives thereof, if appropriate in a mixture with a further dicarboxylic acid (D₂) or derivatives thereof, with at least one aliphatic or aromatic compound (Cₓ) which has at least 3 identical or different groups reactive toward acid groups or derivatives thereof,
   or
b) reacting at least one dicarboxylic acid (A₂) having at least one polyisobutylene group or derivatives thereof, if appropriate in a mixture with a further dicarboxylic acid (D₂) or derivatives thereof, with at least one aliphatic or aromatic compound (B₂) which has 2 identical or different groups reactive toward acid groups or derivatives thereof, and at least one aliphatic or aromatic compound (Cₓ) which has more than two identical or different groups reactive toward acid groups or derivatives thereof, with elimination of water or alcohols R¹OH where R¹ is a straight-chain or branched, aliphatic, cycloaliphatic, araliphatic or aromatic hydrocarbon radical having from 1 to 20 carbon atoms, and x is greater than 2, preferably between 3 and 8,
c) or reacting at least one aliphatic or aromatic compound (B₂) which has two identical or different groups reactive toward acid groups or derivatives thereof with at least one dicarboxylic acid (A₂) having polyisobutylene groups or derivatives thereof, if appropriate in a mixture with a further dicarboxylic acid (D₂) or derivatives thereof, and at least one aliphatic or aromatic carboxylic acid (D_{y}) or derivatives thereof which has more than two acid groups, with elimination of water or alcohols R¹OH where R¹ is a straight-chain or branched, aliphatic, cycloaliphatic, araliphatic or aromatic hydrocarbon radical having from 1 to 20 carbon atoms, and y is greater than 2, preferably between 3 and 8,
   to give a high-functionality, highly branched or high-functionality, hyperbranched polycondensation product,
   the ratio of the reactive partners in the reaction mixture being selected so as to establish a molar ratio of molecules having groups reactive toward acid groups to molecules having acid groups of from 2:1 to 1:2, preferably from 1.5:1 to 1:2, more preferably from 0.9:1 to 1:1.5 and most preferably of 1:1.

The invention further provides the high-functionality, highly branched or high-functionality, hyperbranched polymers prepared by this process.

For the process according to the invention, it is possible to use both polyisobutylenes from uncontrolled polymerization processes and, preferably, from controlled polymerization processes. In addition, preference is given to using polyisobutylenes which have at least 60 mol % of reactive end groups.

In the context of this invention, hyperbranched polymers are understood to mean uncrosslinked macromolecules having polyisobutylene groups, which have both structural and molecular nonuniformity. One possible structure is based on a central molecule in the same way as dendrimers, but with nonuniform chain length of the branches. Another possibility is a linear structure with functional pendant groups, or else, as a combination of the two extremes, linear and branched molecular moieties. For a definition of dendrimeric and hyperbranched polymers, see also P. J. Flory, J. Am. Chem. Soc. 1952, 74, 2718 and H. Frey et al., Chemistry—A European Journal, 2000, 6, No. 14, 2499.

In the context of the present invention, “hyperbranched” is understood to mean that the degree of branching (DB) is from 10 to 99.9%, preferably from 20 to 99%, more preferably 20-95%.

In the context of the present invention, “dendrimeric” is understood to mean that the degree of branching is 99.9-100%. For a definition of the “degree of branching”, see H. Frey et al., Acta Polym. 1997, 48, 30.

The degree of branching is defined as

DB=100*(T+Z)/(T+Z+L)

where T is the mean number of terminal monomer units, Z is the mean number of branched monomer units and L is the mean number of linear monomer units. For a definition of the “degree of branching”, see also H. Frey et al., Acta Polym. 1997, 48, 30.

The following specific statements about the invention should be made:

The compounds (A₂) are compounds which have at least one, preferably exactly one, polyisobutene group and at least two, preferably exactly two, carboxylic acid groups or derivatives thereof.

Reaction products of an ene reaction between polyisobutene and fumaryl chloride, fumaric acid, itaconic acid, itaconyl chloride, maleyl chloride, maleic anhydride and/or maleic acid, and/or the esters of the acids, are preferable over the above-mentioned alternating copolymers with comb structure.

In a preferred embodiment, they are 1:1 (mol/mol) reaction products of an ene reaction between a polyisobutene and fumaryl chloride, fumaric acid, itaconic acid, itaconyl chloride, maleyl chloride, maleic anhydride and/or maleic acid, and/or the esters of the acids, preferably with maleic anhydride or of maleyl chloride, more preferably with maleic anhydride.

The polyisobutenes are preferably those which have end groups formed from vinyl isomer and/or vinylidene isomer to an extent of at least 60 mol %.

The number-average molar mass Mₙ of the compounds (A₂) is preferably at least 100, more preferably at least 200. In general, the number-average molar mass Mₙ of the compounds (A₂) is up to 5000, more preferably up to 2000.

In a particularly preferred embodiment, the compounds (A₂) have a number-average molar mass Mₙ of 1000+/−500 g/mol.

Dicarboxylic acids (D₂) have exactly two carboxyl groups or derivatives thereof. These compounds may be aliphatic, cycloaliphatic, araliphatic or aromatic and have preferably up to 20 carbon atoms, more preferably up to 12 carbon atoms.

The dicarboxylic acids (D₂) include, for example, aliphatic dicarboxylic acids such as oxalic acid, malonic acid, succinic acid, glutaric acid, adipic acid, pimelic acid, suberic acid, azelaic acid, sebacic acid, undecanedicarboxylic acid, dodecanedicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid. It is also possible to use aromatic dicarboxylic acids, for example phthalic acid, isophthalic acid or terephthalic acid. Unsaturated dicarboxylic acids such as maleic acid or fumaric acid can also be used.

The dicarboxylic acids mentioned may also be substituted by one or more radicals selected from

C₁-C₁₀-alkyl groups, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, iso-amyl, n-hexyl, isohexyl, sec-hexyl, n-heptyl, isoheptyl, n-octyl, 2-ethylhexyl, n-nonyl or n-decyl,

C₃-C₁₂-cycloalkyl groups, for example cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl;

alkylene groups such as methylene or ethylidene or

C₆-C₁₄-aryl groups, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, more preferably phenyl.

Examples of representatives of substituted dicarboxylic acids include: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

It is also possible to use mixtures of two or more of the aforementioned dicarboxylic acids.

The dicarboxylic acids can be used either in protonated or unprotonated form, preferably in protonated form as such or in the form of derivatives.

Derivatives are preferably understood to mean
the anhydrides in question, in monomeric or else polymeric form,
mono- or dialkyl esters, preferably mono- or dimethyl esters or the corresponding mono- or diethyl esters, but also the mono- and dialkyl esters derived from higher alcohols, for example n-propanol, isopropanol, n-butanol, isobutanol, tert-butanol, n-pentanol, n-hexanol,
and also mono- and divinyl esters and
mixed esters, preferably methyl ether esters.

In the context of the present invention, it is also possible to use a mixture of a dicarboxylic acid and one or more of its derivatives. It is equally possible in the context of the present invention to use a mixture of two or more different derivatives of one or more dicarboxylic acids.

Particular preference is given to using malonic acid, succinic acid, glutaric acid, adipic acid, 1,2-, 1,3- or 1,4-cyclohexanedicarboxylic acid (hexahydrophthalic acids), phthalic acid, isophthalic acid, terephthalic acid or their mono- or dialkyl esters.

Compounds (D_{y}) have more than two carboxyl groups or derivatives thereof, preferably from 3 to 8, more preferably from 3 to 6. These compounds may be aliphatic, cycloaliphatic, araliphatic or aromatic and have preferably up to 20 carbon atoms, more preferably up to 12 carbon atoms.

Convertible tricarboxylic acids or polycarboxylic acids (D_{y}) are, for example, aconitic acid, 1,3,5-cyclohexanetricarboxylic acid, 1,2,4-benzenetricarboxylic acid, 1,3,5-benzenetricarboxylic acid, 1,2,4,5-benzenetetracarboxylic acid (pyromellitic acid) and mellitic acid, and low molecular weight polyacrylic acids, for example up to a molar mass up to 2000 g/mol, preferably up to 1000 g/mol and more preferably up to 500 g/mol.

Tricarboxylic acids or polycarboxylic acids (D_{y}) can be used in the inventive reaction either as such or else in the form of derivatives.

Derivatives are preferably understood to mean
the anhydrides in question, in monomeric or else polymeric form,
mono-, di- or trialkyl esters, preferably mono-, di- or trimethyl esters or the corresponding mono-, di- or triethyl esters, but also the mono-, di- and triesters derived from higher alcohols, for example n-propanol, isopropanol, n-butanol, isobutanol, tert-butanol, n-pentanol, n-hexanol, and also mono-, di- or trivinyl esters,
and mixed methyl ether esters.

In the context of the present invention, it is also possible to use a mixture of a tri- or polycarboxylic acid and one or more of its derivatives, for example a mixture of pyromellitic acid and pyromellitic dianhydride. It is equally possible in the context of the present invention to use a mixture of a plurality of different derivatives of one or more tri- or polycarboxylic acids, for example a mixture of 1,3,5-cyclohexanetricarboxylic acid and pyromellitic dianhydride.

Groups reactive toward acid groups or derivatives thereof are preferably hydroxyl (—OH), primary amino groups (—NH₂), secondary amino groups (—NHR), epoxy groups or thiol groups (—SH), more preferably hydroxyl or primary or secondary amino groups and most preferably hydroxyl groups.

Secondary amino groups can be substituted by C₁-C₁₀-alkyl, C₃-C₁₂-cycloalkyl, aralkyl or C₆-C₁₄-aryl as R radicals.

The compounds reactive toward acid groups (B₂) used according to the present invention are, for example, difunctional alcohols such as ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, 1,2- or 1,3-cyclopentanediol, 1,2-, 1,3- or 1,4-cyclohexanediol, 1,2-, 1,3- or 1,4-bis(hydroxymethyl)cyclohexane, bis(hydroxyethyl)cyclohexanes, neopentyl glycol, 2-methyl-2,4-pentanediol, 2,4-dimethyl-2,4-pentanediol, 2-methyl-1,3-pentanediol, 2-ethyl-1,3-hexanediol, 2-propyl-1,3-heptanediol, 2,4-diethyloctane-1,3-diol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, where n is an integer and n≧4, polytetrahydrofurans having a molar mass up to 2000, polycaprolactones or mixtures of two or more representatives of the above compounds. It is possible for one or even both hydroxyl groups in the aforementioned diols to be substituted by SH groups. Preference is given to ethylene glycol, 1,2-propanediol, 1,3-propanediol, 1,4-butanediol, 1,5-pentanediol, 1,6-hexanediol, 1,8-octanediol, 1,3- and 1,4-bis(hydroxymethyl)cyclohexane, and also diethylene glycol, triethylene glycol, dipropylene glycol and tripropylene glycol.

The compounds (B₂) used may also be molecules having one hydroxyl and one amino group, for example ethanolamine, 2-aminopropanol, 3-aminopropanol, isopropanolamine, 2-, 3- or 4-amino-1-butanol, 6-amino-1-hexanol, N-methyl-ethanolamine, 2-(ethylamino)ethanol, 1-(ethylamino)-2-propanol 2-(butylamino)ethanol, 2-(cyclohexylamino)ethanol, 2-amino-2-methyl-1-propanol, 2-(2-aminoethoxy)ethanol, 9-amino-3,6-dioxanonan-1-ol or 2-(phenylamino)ethanol.

The compounds (B₂) used are also difunctional amines, for example ethylenediamine, N-alkylethylenediamine, the propylenediamines (1,2-diaminopropane and 1,3-diaminopropane), 2,2-dimethyl-1,3-propylenediamine, N-alkylpropylenediamine, piperazine, tetramethylenediamine (1,4-diaminobutane), N-alkylbutylenediamine, N,N′-dimethylethylenediamine, pentanediamine, hexamethylenediamine, N-alkylhexamethylenediamine, heptanediamine, octanediamine, nonanediamine, decanediamine, dodecanediamine, hexadecanediamine, 1,3-diamino-2,2-diethyl-propane, 1,3-bis(methylamino)propane, 1,5-diamino-2-methylpentane, 3-(propylamino)propylamine, N,N′-bis(3-aminopropyl)piperazine, N,N′-bis(3-amino-propyl)piperazine, isophoronediamine (IPDA), tolylenediamine, xylylenediamine, diaminodiphenylmethane, cyclohexylenediamine, bis(aminomethyl)cyclohexane, diaminodiphenyl sulfone, 2-butyl-2-ethyl-1,5-pentamethylenediamine, 2,2,4- or 2,4,4-trimethyl-1,6-hexamethylenediamine, 2-aminopropylcyclohexylamine, 3(4)-aminomethyl-1-methylcyclohexylamine, 1,4-diamino-4-methylpentane, amine-terminated polyoxyalkylene polyols (so-called Jeffamines from Huntsmann Corp., Houston, Tex.) or amine-terminated polytetramethylene glycols.

Examples of such diamines are the so-called Jeffamines® D or ED series. The D series is amino-functionalized polypropylenediols composed of 3-4 1,2-propylene units (Jeffamine® D-230, mean molar mass 230), 6-7 1,2-propylene units (Jeffamine® D-400, mean molar mass 400), an average of approx. 34 1,2-propylene units (Jeffamine® D-2000, mean molar mass 2000) or an average of approx. 69 1,2-propylene units (Jeffamine® XTJ-510 (D-4000), mean molar mass 4000). These products may in part also be present in the form of amino alcohols. The ED series is diamines based on polyethylene oxides which have ideally been propoxylated on both sides, for example Jeffamine® HK-511 (XTJ-511) composed of 2 ethylene oxide and 2 propylene oxide units with a mean molar mass of 220, Jeffamine® XTJ-500 (ED-600) composed of 9 ethylene oxide and 3.6 propylene oxide units with a mean molar mass of 600 and Jeffamine® XTJ-502 (ED-2003) composed of 38.7 ethylene oxide and 6 propylene oxide units with a mean molar mass of 2000.

The compounds (B₂) may also have further functional groups, for example carboxyl groups or ester groups. Examples of such compounds are dimethylolpropionic acid, dimethylolbutyric acid or neopentyl glycol hydroxypivalate.

However, preferred compounds (B₂) do not bear any further functional groups apart from groups reactive toward carboxyl groups or derivatives thereof.

Preferred compounds (B₂) are alcohols or amino alcohols, more preferably alcohols.

Compounds (Cₓ) have an average of more than 2, preferably from 3 to 8, more preferably from 3 to 6 groups reactive toward acid groups and derivatives thereof.

They may be aliphatic, cycloaliphatic, araliphatic or aromatic and have generally not more than 100, preferably not more than 50, more preferably not more than 20 carbon atoms.

At least trifunctional compounds having groups reactive toward acid groups (Cₓ) comprise trifunctional or higher-functionality alcohols such as glycerol, trimethylolmethane, trimethylolethane, trimethylolpropane, 1,2,4-butanetriol, tris(hydroxymethyl) isocyanurate, tris(hydroxyethyl) isocyanurate (THEIC), pentaerythritol, diglycerol, triglycerol or higher condensation products of glycerol, di(trimethylolpropane), di(pentaerythritol), inositols, sorbitol or sugars, for example glucose, fructose or sucrose, trifunctional or higher-functionality polyetherols based on trifunctional or higher-functionality alcohols and ethylene oxide, propylene oxide or butylene oxide. Particular preference is given to glycerol, diglycerol, triglycerol, trimethylolethane, trimethylolpropane, 1,2,4-butanetriol, pentaerythritol, and their polyetherols based on ethylene oxide or propylene oxide.

Preference is given to compounds (B₂) or (Cₓ) compounds of the formula (Ia) to (Id),

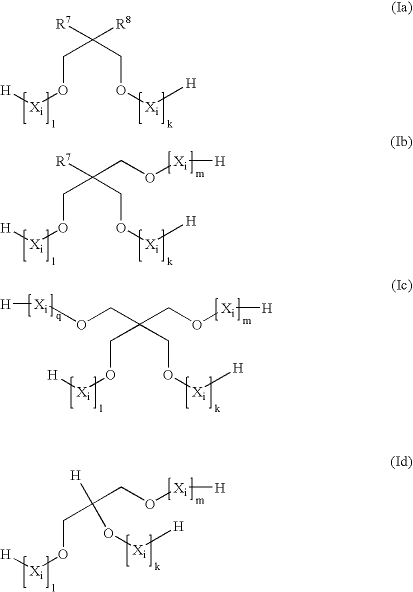

where
R⁷ and R⁸ are each independently hydrogen or C₁-C₁₈-alkyl optionally substituted by aryl, alkyl, aryloxy, alkyloxy, heteroatoms and/or heterocycles,
k, l, m, q are each independently an integer from 1 to 15, preferably from 1 to 10 and more preferably from 1 to 7 and
each Xᵢ for i=1 to k, 1 to l, 1 to m and 1 to q may each independently be selected from the group of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O— and —CHPh-CH₂—O—, preferably from the group of —CH₂—CH₂—O—, —CH₂—CH(CH₃)—O— and —CH(CH₃)—CH₂—O—, and more preferably —CH₂—CH₂—O—,
where Ph is phenyl and Vin is vinyl.

In these formulae, C₁-C₁₈-alkyl optionally substituted by aryl, alkyl, aryloxy, alkyloxy, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, preferably methyl, ethyl or n-propyl, most preferably methyl or ethyl.

Preference is given to one- to thirtyfold and particular preference to three- to twentyfold ethoxylated, propoxylated or mixed ethoxylated and propoxylated and especially exclusively ethoxylated neopentyl glycol, trimethylolpropane, trimethylolethane or pentaerythritol or glycerol.

At least trifunctional compounds having groups reactive toward acid groups (Cₓ) further comprise trifunctional or higher-functionality amino alcohols such as tris(hydroxymethyl)amine, tris(hydroxyethyl)amine, tris(hydroxypropyl)amine, diethanolamine, dipropanolamine, diisopropanolamine, di-sec-butanolamine, tris(hydroxymethyl)aminomethane, tris(hydroxyethyl)aminomethane, 3-amino-1,2-propanediol, 1-amino-1-deoxy-D-sorbitol and 2-amino-2-ethyl-1,3-propanediol.

At least trifunctional compounds having groups reactive toward acid groups (Cₓ) further comprise trifunctional or higher-functionality amines such as tris(2-aminoethyl)amine, tris(3-aminopropyl)amine, tris(aminohexyl)amine, trisaminohexane, 4-aminomethyl-1,8-octamethylenediamine, trisaminononane, diethylenetriamine (DETA), dipropylenetri-amine, dibutylenetriamine, dihexylenetriamine, N-(2-aminoethyl)propanediamine, melamine, triethylenetetramine (TETA), tetraethylenepentamine (TEPA), isopropylenetriamine, dipropylenetriamine and N,N′-bis(3-aminopropylethylene-diamine), oligomeric diaminodiphenylmethanes, N,N′-bis(3-aminopropyl)ethylene-diamine, N,N′-bis(3-aminopropyl)butanediamine, N,N,N′,N′-tetra(3-amino-propyl)ethylenediamine, N,N,N′,N′-tetra(3-aminopropyl)butylenediamine, trifunctional or higher-functionality amine-terminated polyoxyalkylene polyols (so-called Jeffamines), trifunctional or higher-functionality polyethyleneimines or trifunctional or higher-functionality polypropyleneimines.

Examples of triamines are Jeffamine® T-403, a triamine based on a trimethylolpropane modified with 5-6 1,2-propylene units, Jeffamine® T-5000, a triamine based on a glycerol modified with approx. 85 1,2-propylene units, and Jeffamine® XTJ-509 (T-3000), a triamine based on a glycerol modified with 50 1,2-propylene units.

Preferred compounds (Cₓ) are alcohols or amino alcohols, more preferably alcohols.

The process according to the invention is carried out in substance or in the presence of a solvent. Suitable solvents are, for example, hydrocarbons such as paraffins or aromatics. Particularly suitable paraffins are n-heptane and cyclohexane. Particularly suitable aromatics are toluene, ortho-xylene, meta-xylene, para-xylene, xylene as an isomer mixture, ethylbenzene, chlorobenzene and ortho- and meta-dichlorobenzene. Also suitable as solvents are ethers, for example dioxane or tetrahydrofuran and ketones, for example methyl ethyl ketone and methyl isobutyl ketone.

As already detailed above, unconverted polyisobutenes may also be present as inert diluents.

Further usable aromatic hydrocarbon mixtures are those which comprise predominantly aromatic C₇- to C₁₋₄-hydrocarbons and may comprise a boiling range from 110 to 300° C., more preferably toluene, o-, m- or p-xylene, trimethylbenzene isomers, tetramethylbenzene isomers, ethylbenzene, cumene, tetrahydronaphthalene and mixtures comprising them.

Examples of these are the Solvesso® brands from ExxonMobil Chemical, particularly Solvesso® 100 (CAS No. 64742-95-6, predominantly C₉ and C₁₀ aromatics, boiling range about 154-178° C.), 150 (boiling range about 182-207° C.) and 200 (CAS No. 64742-94-5), and the Shellsol® brands from Shell. Hydrocarbon mixtures of paraffins, cycloparaffins and aromatics are also commercially available under the names Kristallöl (for example Kristallöl 30, boiling range about 158-198° C., or Kristallöl 60: CAS No. 64742-82-1), petroleum spirit (for example likewise CAS No. 64742-82-1) or Solvent naphtha (light: boiling range about 155-180° C., heavy: boiling range about 225-300° C.). The aromatics content of such hydrocarbon mixtures is generally more than 90% by weight, preferably more than 95% by weight, more preferably more than 98% by weight and most preferably more than 99% by weight. It may be sensible to use hydrocarbon mixtures with a particularly reduced content of naphthalene.

According to the invention, the amount of solvent added is at least 0.1% by weight based on the mass of the starting materials to be converted which are used, preferably at least 1% by weight and more preferably at least 10% by weight. It is also possible to use excesses of solvents based on the mass of starting materials to be converted which are used, for example from 1.01- to 10-fold. Amounts of solvent of more than 100 times the mass of starting materials to be converted which are used are not advantageous because the reaction rate declines significantly in the case of significantly lower concentrations of the reactants, which leads to uneconomic long reaction times.

To carry out the process according to the invention, it is possible to work in the presence of a dehydrating agent as an additive, which is added at the start of the reaction. Suitable examples are molecular sieves, especially 4 Å molecular sieve, MgSO₄ and Na₂SO₄. It is also possible to add further dehydrating agent during the reaction or to replace dehydrating agent with fresh dehydrating agent. It is also possible to distill off alcohol or water formed during the reaction and, for example, to use a water separator, in which case the water is removed with the aid of an azeotroping agent.

The process according to the invention can be carried out in the absence of catalysts. However, when catalysts are employed, preference is given to using acidic inorganic, organometallic or organic catalysts or mixtures of a plurality of acidic inorganic, organometallic or organic catalysts.

In the context of the present invention, acidic inorganic catalysts are, for example, sulfuric acid, sulfates and hydrogensulfates, such as sodium hydrogensulfate, phosphoric acid, phosphonic acid, hypophosphorous acid, aluminum sulfate hydrate, alum, acidic silica gel (having a pH in water of ≦6, in particular ≦5) and acidic alumina. It is also possible, for example, to use aluminum compounds of the general formula Al(OR²)₃ and titanates of the general formula Ti(OR²)₄ as acidic inorganic catalysts, where the R² radicals may each be the same or different and are independently selected from

C₁-C₂₀-alkyl radicals, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, iso-amyl, n-hexyl, isohexyl, sec-hexyl, n-heptyl, isoheptyl, n-octyl, 2-ethylhexyl, n-nonyl, n-decyl, n-dodecyl, n-hexadecyl or n-octadecyl. Preference is given to the C₁- to C₁₀-alkyl radicals, particular preference to C₁- to C₄-alkyl.

C₃-C₁₂-cycloalkyl radicals, for example cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl.

The R² radicals in Al(OR²)₃ and Ti(OR²)₄ are preferably each the same and are selected from butyl, isopropyl or 2-ethylhexyl.

Preferred acidic organometallic catalysts are, for example, selected from dialkyltin oxides R³₂SnO or dialkyltin esters R³₂Sn(OR⁴)₂, where R³ and R⁴ may be selected from C₁-C₂₀-alkyl or C₃-C₁₂-cycloalkyl and may be the same or different. Particularly preferred representatives of acidic organometallic catalysts are dibutyltin oxide and dibutyltin dilaurate.

Preferred acidic organic catalysts are acidic organic compounds having, for example, phosphate groups, sulfonic acid groups, sulfate groups or phosphonic acid groups. Particular preference is given to sulfonic acids, for example para-toluenesulfonic acid. The acidic organic catalysts used may also be acidic ion exchangers, for example sulfonic acid-containing polystyrene resins which have been crosslinked with about 2 mol % of divinylbenzene.

It is also possible to use combinations of two or more of the aforementioned catalysts. It is also possible to use such organic or organometallic or else inorganic catalysts which are present in the form of discrete molecules in immobilized form, for example on silica gel or on zeolites.

When the use of acidic inorganic, organometallic or organic catalysts is desired, from 0.1 to 10% by weight, preferably from 0.2 to 2% by weight of catalyst is used in accordance with the invention.

The process according to the invention is preferably carried out under an inert gas atmosphere, i.e., for example, under carbon dioxide, nitrogen or noble gas, among which particular mention should be made of argon.

A gas inert under the reaction conditions can preferably be passed through the reaction mixture, so that volatile compounds are stripped out of the reaction mixture.

The process according to the invention is carried out at temperatures of from 60 to 250° C. Preference is given to working at temperatures of from 80 to 200° C., more preferably at from 100 to 180° C.

The pressure conditions of the process according to the invention are uncritical per se. It is possible to work at highly reduced pressure, for example at from 1 to 500 mbar. The process according to the invention can also be carried out at pressures above 500 mbar. For reasons of simplicity, preference is given to reaction at atmospheric pressure; but it is also possible to perform it at slightly elevated pressure, for example up to 1200 mbar. It is also possible to work under highly elevated pressure, for example at pressures up to 10 bar. Preference is given to reaction at atmospheric pressure and at reduced pressures.

The reaction time of the process according to the invention is typically from 10 minutes to 48 hours, preferably from 30 minutes to 24 hours and more preferably from 1 to 12 hours.

After the reaction has ended, the high-functionality, highly branched and high-functionality, hyperbranched polymers can be isolated easily, for example by filtering off the catalyst and, if appropriate, removing the solvent, the removal of the solvent being carried out typically at reduced pressure. Further suitable workup methods are, for example, precipitation of the polymer after addition of water and subsequent washing and drying.

The present invention further provides the high-functionality, highly branched or high-functionality, hyperbranched polymers obtainable by the process according to the invention. They feature particularly low contents of resinifications.

In the case of the preferred inventive compounds, the gel content of the hyperbranched compounds, i.e. the insoluble fraction in the case of storage at room temperature (23° C.) under tetrahydrofuran for 24 hours divided by the total amount of the sample and multiplied by 100, is not more than 20%, preferably not more than 10% and more preferably not more than 5%.

The inventive polymers have a weight-average molecular weight M_{w} of from 1000 to 1000000 g/mol, preferably from 1500 to 500000, more preferably from 1500 to 300000 g/mol. The polydispersity is from 1.1 to 150, preferably from 1.2 to 120, more preferably from 1.2 to 100 and most preferably from 1.2 to 50. They are typically very highly soluble, i.e. it is possible to prepare clear solutions with up to 50% by weight, in some cases even up to 80% by weight, of the inventive polymers in various solvents such as toluene, xylene, hexane, cyclohexane, heptane, octane, isooctane, tetrahydrofuran (THF), ethyl acetate, n-butyl acetate, ethanol and numerous other solvents, without gel particles being detectable with the naked eye.

The inventive high-functionality, highly branched and high-functionality, hyperbranched polymers are carboxy-terminated, carboxyl- and hydroxyl-terminated, carboxyl- and amino-terminated, carboxyl-, hydroxyl- and amino-terminated or hydroxyl-terminated, and may be used to prepare, for example, polyaddition or polycondensation products, for example polycarbonates, polyurethanes, polyamides, polyesters and polyethers. Preference is given to the use of the inventive hydroxyl-terminated high-functionality, highly branched and high-functionality, hyperbranched polyesters for preparing polycarbonates, polyesters or polyurethanes.

The inventive high-functionality, highly branched and high-functionality, hyperbranched polymers generally have an acid number to DIN 53240, part 2 of from 0 to 50 mg KOH/g, preferably from 1 to 35 mg KOH/g and more preferably from 2 to 20 mg KOH/g.

The inventive high-functionality, highly branched and high-functionality, hyperbranched polymers generally have a hydroxyl number to DIN 53240, part 2 of from 10 to 250 mg KOH/g, preferably from 20 to 150 mg KOH/g and more preferably from 25 to 100 mg KOH/g.

The inventive high-functionality, highly branched and high-functionality, hyperbranched polymers generally have a glass transition temperature (measured by the ASTM method D3418-03 by DSC) of from −50 to 100° C., preferably from −30 to 80° C.

The inventive high-functionality, highly branched and high-functionality, hyperbranched polymers generally have an HLB value of from 1 to 20, preferably from 3 to 20 and more preferably from 4 to 20.

If alkoxylated alcohols are used to form the inventive high-functionality, highly branched and high-functionality, hyperbranched polymers, the HLB value may also be less than 8, preferably from 5 to 8.

The HLB value is a measure of the hydrophilic and lipophilic fraction of a chemical compound. The determination of the HLB value is explained, for example, in W. C. Griffin, Journal of the Society of Cosmetic Chemists, 1949, 1, 311, and W. C. Griffin, Journal of the Society of Cosmetic Chemists, 1954, 5, 249.

To this end, 1 g of sample material is dissolved in a mixture of 4% benzene and 96% dioxane and water is added until the occurrence of cloudiness. The value thus determined is generally proportional to the HLB value.

For such high-functionality, highly branched and high-functionality, hyperbranched polymers which comprise compounds (B₂) and/or (Cₓ) which comprise ethylene oxide groups in incorporated form, the HLB can also be determined by the method of C. D. Moore, M. Bell, SPC Soap, Perfum. Cosmet. 29 (1956) 893 by the formula

HLB=(number of ethylene oxide groups)*100/(number of carbon atoms in the lipophilic molecular moiety).

In the context of this invention, a high-functionality polymer is a product which, in addition to the polyisobutylene groups and the ester or amide groups which form the polymer skeleton, has, terminally or laterally, also at least three, preferably at least six, more preferably at least ten functional groups. The functional groups are acid groups and/or amino or hydroxyl groups. There is in principle no upper limit on the number of terminal or pendant functional groups, but products with a very high number of functional groups can have undesired properties, for example high viscosity. The high-functionality polyesters of the present invention usually have not more than 500 terminal or pendant functional groups, preferably not more than 100 terminal or pendant functional groups.

A further aspect of the present invention is the use of the inventive high-functionality, highly branched and high-functionality, hyperbranched polymers for preparing polyaddition or polycondensation products, for example polycarbonates, polyurethanes, polyamides, polyesters and polyethers. Preference is given to the use of the inventive hydroxyl-terminated high-functionality, highly branched and high-functionality, hyperbranched polyesters for preparing polycarbonates, polyesters or polyurethanes.

A further aspect of the present invention is the use of the inventive high functionality, highly branched and high-functionality, hyperbranched polymers and of the polyaddition or polycondensation products prepared from high-functionality, highly branched and high-functionality, hyperbranched polymers as a component of printing inks, adhesives, coatings, foams, coverings and varnishes. A further aspect of the present invention is that of printing inks, adhesives, coatings, foams, coverings and varnishes comprising the inventive high-functionality, highly branched and high-functionality, hyperbranched polymers or polyaddition or polycondensation products prepared from the inventive high-functionality, highly branched and high-functionality, hyperbranched polymers, which feature outstanding performance properties.

After the reaction, i.e. without further modification, the high-functionality, highly branched polymers formed by the process according to the present invention are terminated with hydroxyl groups, amino groups and/or with acid groups. They dissolve readily in various solvents, for example in water, alcohols such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, propylene carbonate, toluene, xylene, chlorobenzene, dichlorobenzene, hexane, cyclohexane, heptane, octane or isooctane.

In a further preferred embodiment, the inventive polymers, in addition to the functional groups already obtained by the reaction, may obtain further functional groups. The functionalization can be effected during the molecular weight buildup or else subsequently, i.e. after the actual polycondensation has ended.

When components which have further functional groups or functional elements in addition to hydroxyl, amino or carboxyl groups are added before or during the molecular weight buildup, a polymer is obtained with randomly distributed functionalities other than the carboxyl, amino or hydroxyl groups.

Such effects can be achieved, for example, by addition of compounds during the polycondensation which, in addition to hydroxyl groups, primary or secondary amino groups or carboxyl groups, bear further functional groups or functional elements such as mercapto groups, tertiary amino groups, ether groups, in particular polyethylene oxide and/or propylene oxide groups, carbonyl groups, sulfonic acids or derivatives of sulfonic acids, sulfinic acids or derivatives of sulfinic acids, phosphonic acids or derivatives of phosphonic acids, phosphinic acids or derivatives of phosphonic acids, silane groups, siloxane groups, aryl radicals or long-chain alkyl radicals, or fluorinated or perfluorinated aryl or alkyl radicals.

For modification with mercapto groups, it is possible, for example, to use mercaptoethanol. Tertiary amino groups can be obtained, for example, by incorporating N-methyldiethanolamine, N-methyldipropanolamine or N,N-dimethylethanolamine. Ether groups can be generated, for example, by incorporating difunctional or higher-functionality polyetherols by condensation. Reaction with long-chain alkanediols allows long-chain alkyl radicals to be introduced; the reaction with alkyl or aryl diisocyanates generates polymers having alkyl, aryl and urethane or urea groups.

For a modification, it is advantageously also possible to use compounds which bear at least one primary and/or secondary amino group and at least one carboxyl, sulfonic acid or phosphonic acid group.

Examples of these are amino acids, hydroxyalkyl- or -arylsulfonic acids, for example taurine or N-methyltaurine, or N-cyclohexylaminopropane- and -ethanesulfonic acid.

Examples of amino acids are glycine, alanine, β-alanine, valine, lysine, leucine, isoleucine, tert-leucine, phenylalanine, tyrosine, tryptophan, proline, aspartic acid, glutamic acid, asparagine, glutamine, serine, threonine, cysteine, methionine, arginine, histidine, 4-aminobutyric acid, cystine, citrulline, theanine, homocysteine, 4-hydroxyproline, alliin or ornithine.

Subsequent functionalization can be obtained by reacting the high-functionality, highly branched or high-functionality, hyperbranched polymer obtained, in an additional process step, with a suitable functionalizing reagent which can react with the OH and/or NH and/or carboxyl groups of the polymer.

High-functionality, highly branched or high-functionality, hyperbranched polymers comprising hydroxyl groups or amino groups can be modified, for example, by adding molecules comprising isocyanate groups. For example, polymers comprising urethane groups or urea groups can be obtained by reacting with alkyl or aryl isocyanates. In addition, high-functionality polymers comprising hydroxyl groups or amino groups may also be converted to high-functionality polyether polyols by reacting with alkylene oxides, for example ethylene oxide, propylene oxide or butylene oxide. These compounds can then be obtained, for example, in water-soluble or water-dispersible form.

High-functionality polymers comprising carboxyl or amino groups can also be converted, by adding acidic or basic components, to polymers comprising carboxylate or ammonium groups, which then, for example, have an improved water solubility or water dispersibility.

The invention will be illustrated in detail by the examples which follow.

### Preparation of the Inventive Products

### WORKING METHOD FOR EXAMPLES 1-14

A glass flask equipped with stirrer, internal thermometer, gas inlet tube and descending cooler with vacuum connection and collecting vessel was initially charged with the reactants according to Table 1 and heated to 100° C. under a gentle nitrogen stream. Subsequently, based on the mass of PIBSA, 200 ppm of dibutyltin dilaurate were added, the mixture was heated to an internal temperature of 180° C. with stirring and under a nitrogen stream, the pressure was reduced slowly to 10 mbar and water was removed via the condenser. The time stated in Table 1 specifies the reaction time at 180° C.

The molecular weight was controlled via the reaction time or via the monitoring of the amount of water removed.

The polymer was subsequently discharged while hot and analyzed by the methods specified below.

The characteristic data of the products are stated in Table 1

### WORKING METHOD FOR EXAMPLES 15-18

In a glass flask equipped with stirrer, internal thermometer and water separator, 1 mol of PIBSA 550 or 0.5 mol of PIBSA 1000, the further reactants according to Table 2, 150 ml of toluene and 0.1 g of dibutyltin dilaurate were combined and the mixture was boiled under reflux, in the course of which the water of reaction was removed by means of the water separator. After the majority of the water had been distilled off in accordance with the time stated as a guide in Table 2, the reaction was terminated, the mixture was transferred to a one-neck flask and the solvent was removed on a rotary evaporator at 90° C. under reduced pressure.

The molecular weight was controlled via the monitoring of the amount of water removed.

The polymer was subsequently discharged while warm and analyzed by the methods specified below.

The data for the products are in Table 2.

### EXAMPLE 19

A glass flask equipped with stirrer, internal thermometer and water separator was initially charged with 13.3 g of tris(2-aminoethyl)amine which were mixed with 50 g of water and 30 g of xylene. Subsequently, 50 g of PIBSA dissolved in 20 g of xylene were added at room temperature within 30 min and then, once again, a mixture of 25 g of water and 25 g of xylene was added. The mixture was heated to 80° C. and stirred at this temperature for 1 h. Subsequently, the water was removed via the water separator. After the majority of the water had been distilled off, the mixture was heated to 140° C. and xylene was removed. After the majority of the xylene had been removed, the reaction mixture was stirred at 160° C. for another 1 h and at 180° C. for a further hour, in the course of which residual amounts of water and xylene were still removed continuously.

The polymer was subsequently discharged while warm and analyzed by GPC analysis. The number-average molecular weight Mₙ was determined to be 1150 g/mol, the weight-average molecular weight M_{w} to be 1500 g/mol.

### Analysis of the Inventive Products:

The polymers were analyzed by gel permeation chromatography at 30° C. with a refractometer as the detector. The mobile phase used was tetrahydrofuran with 0.02 mol/l of triethylamine; the standard used to determine the molecular weight was polystyrene.

The acid number and the OH number were determined to DIN 53240, part 2.

TABLE 1
Composition and analytical data of the products in a solvent-free method

| | | | Reaction | | | | |
|---|---|---|---|---|---|---|---|
| Experiment | | Molar | time (h) at | | | | OH |
| number | Composition | ratio | 180° C. | Mn | Mw | Acid number | number |
| 1 | PIBSA 1000 + diethanolamine | 1:1 | 12 | 3700 | 18400 | 1.4 | 26 |
| 2 | PIBSA 1000 + TMP | 1:1 | 6 | 1900 | 4600 | 10.5 | 64 |
| 3 | PIBSA 1000 + TMP | 1:1 | 9 | 2600 | 7000 | 3.5 | 64 |
| 4 | PIBSA 1000 + TMP × 3 EO | 1:1 | 12 | 2100 | 7300 | 3.0 | 79 |
| 5 | PIBSA 1000 + TMP × 12 EO | 1:1 | 12 | 2100 | 7900 | 6.1 | 61 |
| 6 | PIBSA 1000 + TMP × 12 EO | 2:1 | 6 | 3200 | 23000 | 22.0 | n.d. |
| 7 | PIBSA 1000 + glycerol × 18 EO | 1:1 | 8 | 2100 | 5600 | 17.0 | 36 |
| 8 | PIBSA 1000 + glycerol × 12 EO | 1:1 | 8 | 2100 | 6100 | 15.0 | 43 |
| 9 | PIBSA 1000 + glycerol × 9 EO | 1:1 | 8 | 2100 | 7700 | 11.0 | 46 |
| 10 | PIBSA 1000 + adipic acid + TMP | 0.8:0.2:1 | 8 | 3400 | 9300 | 5 | 63 |
| 11 | PIBSA 550 + TMP | 1:1 | 6 | 500 | 1800 | 32.9 | 148 |
| 12 | PIBSA 550 + TMP | 1:1 | 9 | 1300 | 4500 | 14.9 | 128 |
| 13 | PIBSA 550 + diethanolamine | 1:1 | 6 | 850 | 3300 | 32.7 | 141 |
| 14 | PIBSA 550 + diethanolamine | 1:1 | 18 | 2400 | 288000 | 2.0 | 76 |

TABLE 2
Composition and analytical data of the products in a solvent method

| Experiment | | Molar | Reaction | | | | OH |
|---|---|---|---|---|---|---|---|
| number | Composition | ratio | time (h) | Mn | Mw | Acid number | number |
| 15 | PIBSA 1000 + triethanolamine | 1:1 | 12 | 2300 | 6900 | 1.9 | 70 |
| 16 | PIBSA 550 + TMP × 3 EO | 1:1 | 12 | 1500 | 6600 | 13.4 | 108 |
| 17 | PIBSA 550 + TMP × 3 EO | 1:1 | 10 | 900 | 2300 | 30.1 | 125 |
| 18 | PIBSA 550 + TMP × 12 EO | 1:1 | 10 | 1100 | 2800 | 22.7 | 98 |

TMP = trimethylolpropane
TMP × n EO = trimethylolpropane, grafted randomly with n ethylene oxide units
glycerol × n EO = glycerol, grafted randomly with n ethylene oxide units
n.d. = not determined

1. A high-functionality, highly branched or high-functionality, hyperbranched compound obtained by reacting
at least one dicarboxylic acid (A₂) having at least one polyisobutene group or derivatives thereof, with
optionally, at least one aliphatic, cycloaliphatic, araliphatic or aromatic carboxylic acid (D₂) which has exactly two carboxylic acid groups or derivative thereof,
optionally, at least one aliphatic, cycloaliphatic, araliphatic or aromatic carboxylic acid (D₂) which has more than two carboxylic acid groups or derivative thereof, and
at least one compound having at least two groups reactive toward carboxylic acid groups or derivatives thereof, selected from the group consisting of
divalent aliphatic, cycloaliphatic, araliphatic or aromatic compounds (B₂) which have exactly two identical or different groups reactive toward carboxylic acid groups or derivatives thereof, and
aliphatic, cycloaliphatic, araliphatic or aromatic compounds (Cₓ) which have more than two identical or different groups reactive toward carboxylic acid groups or derivatives thereof, wherein
at least one compound (D_{y}) and/or (Cₓ) is present,
and the groups which are reactive to acid groups or their derivatives are selected from the group consisting of hydroxyl groups (—OH), secondary amino groups (—NHR), epoxy groups and thiol groups (—SH) and
the ratio of reactive partners in the reaction are selected so as to maintain a molar ratio of molecules having groups reactive toward acid groups or derivatives thereof to molecules having acid groups or derivatives thereof of from 2:1 to 1:2.

2. The high-functionality, highly branched or high-functionality, hyperbranched compound according to claim 1, wherein the compound (A₂) is a reaction product of an ene reaction between polyisobutene and fumaryl chloride, fumaric acid, itaconic acid, itaconyl chloride, maleyl chloride, maleic anhydride and/or maleic acid, and/or the esters of the acids.

3. The high-functionality, highly branched or high-functionality, hyperbranched compound according to claim 1, wherein the compound (A₂) has exactly 2 carboxyl groups or derivatives thereof.

4. The high-functionality, highly branched or high-functionality, hyperbranched compound according to claim 2, wherein the polyisobutene has at least one end group formed from a vinyl isomer and/or a vinylidene isomer to an extent of at least 60 mol %.

5. The high-functionality, highly branched or high-functionality, hyperbranched compound according to claim 1, wherein the compound (A₂) has a number-average molar mass Mₙ between 100 and 5000.

6. The high-functionality, highly branched or high-functionality, hyperbranched compound according to claim 1, wherein at least one compound (B₂) and/or (Cₓ) corresponds to the formula (Ia) to (Id) 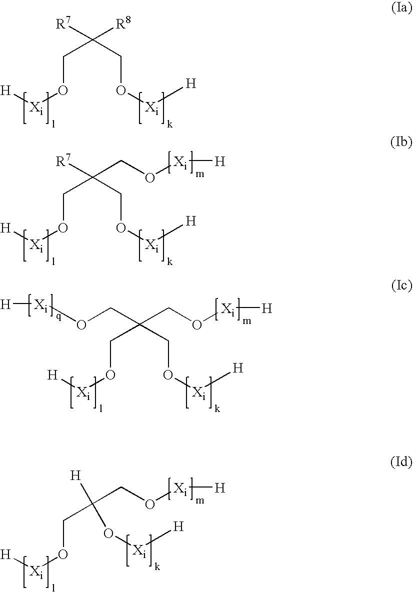
where
R⁷ and R⁸ are each independently hydrogen or C₁-C₁₈-alkyl optionally substituted by aryl, alkyl, aryloxy, alkyloxy, heteroatoms and/or heterocycles,
k, l, m, q are each independently an integer from 1 to 15, and
each Xᵢ for i=1 to k, 1 to l, 1 to m and 1 to q may each independently be selected from the group of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O— and —CHPh-CH₂—O—,
where Ph is phenyl and Vin is vinyl.

7. A process for preparing high-functionality, highly branched or high-functionality, hyperbranched polymers, comprising:
a) either reacting at least one dicarboxylic acid (A₂) having at least one polyisobutylene group or derivatives thereof, optionally in a mixture with a further dicarboxylic acid (D₂) or derivatives thereof, with at least one aliphatic or aromatic compound (Cₓ) which has at least 3 identical or different groups reactive toward acid groups or derivatives thereof,
or
b) reacting at least one dicarboxylic acid (A₂) having at least one polyisobutylene group or derivatives thereof, optionally in a mixture with a further dicarboxylic acid (D₂) or derivatives thereof, with at least one aliphatic or aromatic compound (B₂) which has 2 identical or different groups reactive toward acid groups or derivatives thereof, and at least one aliphatic or aromatic compound (Cₓ) which has more than two identical or different groups reactive toward acid groups or derivatives thereof, with elimination of water or alcohols R¹OH where R¹ is a straight-chain or branched, aliphatic, cycloaliphatic, araliphatic or aromatic hydrocarbon radical having from 1 to 20 carbon atoms, and x is an integer greater than 2,
c) or reacting at least one aliphatic or aromatic compound (B₂) which has two identical or different groups reactive toward acid groups or derivatives thereof with at least one dicarboxylic acid (A₂) having polyisobutylene groups or derivatives thereof, if appropriate in a mixture with a further dicarboxylic acid (D₂) or derivatives thereof, and at least one aliphatic or aromatic carboxylic acid (D_{y}) or derivatives thereof which has more than two acid groups, with elimination of water or alcohols R¹OH where R′ is a straight-chain or branched, aliphatic, cycloaliphatic, araliphatic or aromatic hydrocarbon radical having from 1 to 20 carbon atoms, and y is greater than 2, preferably between 3 and 8,
to give a high-functionality, highly branched or high-functionality, hyperbranched polycondensation product,
wherein the groups which are reactive to acid groups or their derivatives are selected from the group consisting of hydroxyl groups (—OH), secondary amino groups (—NHR), epoxy groups and thiol groups (—SH) and
the ratio of reactive partners in the reaction mixture are selected so as to establish a molar ratio of molecules having groups reactive toward acid groups to molecules having acid groups of from 2:1 to 1:2, preferably from 1.5:1 to 1:2.

8-9. (canceled)
